(19) United States
(12) Patent Application Publication
(10) Pub. No.: US 2006/0172061 A1
(43) Pub. Date: Aug. 3, 2006

(54) Method and apparatus for substrate fabrication

(76) Inventors: Toshimi Kohmura, Tsuchiura-Shi (JP); Michael Walk, Mesa, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/456,160

(22) Filed: Jun. 5, 2003

(51) Int. Cl. B05D 5/12

(52) U.S. Cl. 427/58; 427/96.1; 427/97.7

(57) ABSTRACT

Numerous embodiments of a method and apparatus for forming a substrate are disclosed. In one embodiment, a method for substrate fabrication comprises imprinting one or more features on a substrate, depositing a protective layer on a substantial portion of the top surface of the substrate, applying a metal filled paste to at least a portion of the one or more features, removing a substantial portion of the protective layer, and curing the metal filled paste to form one or more conductive structures.

### BACKGROUND

In order to form electronic assemblies, one or more electronic components, such as integrated circuits (ICs), may be physically and electrically attached to an electronic device substrate, such as a printed circuit board (PCB) or motherboard, for example. Substrates used in electronic assemblies, which may also be referred to as secondary substrates, may be formed at least in part from ceramic or organic materials, for example, and may comprise a number of layers. The one or more layers of these substrates may include conductive devices such as patterned interconnect lines, including traces and trenches, for example. Additionally, one or more through holes, which may be referred to as vias or plated through holes, may be formed between layers of the substrate, and may, along with other conductive devices, provide signal paths between electronic components mounted on the substrate, from one side of a substrate to another, or between layers of the substrate, for example. Conductive devices such as these may be metalized or formed from metal, for example, and may be referred to as features.

Numerous techniques exist for fabricating substrates, which may be used to form electronic assemblies. Current state of the art techniques for fabricating substrates are typically time consuming, and may involve several complex operations that may be expensive and prone to error. As will be shown in more detail hereinafter, a need exists for an improved method for forming substrates that may provide reduced complexity, time of fabrication, and cost of fabrication as compared to one or more currently used techniques.

### BRIEF DESCRIPTION OF THE DRAWINGS

The subject matter regarded as embodiments is particularly pointed out and distinctly claimed in the concluding portion of the specification. Embodiments of the claimed subject matter, however, both as to organization and method of operation, together with objects, features, and advantages thereof, may best be understood by reference to the following detailed description when read with the accompanying drawings in which:

FIG. 1 is a side cross sectional view of an electronic assembly having a substrate with multiple conductive structures, in accordance with one embodiment;

FIG. 2 is an illustration of a side cross sectional view of three phases of formation of a substrate in accordance with one embodiment; and

FIG. 3 is a process flow diagram depicting a method of formation in accordance with one embodiment.

### DETAILED DESCRIPTION

Particular embodiments may comprise a method and apparatus for substrate fabrication. In one embodiment, a method for substrate fabrication comprises imprinting one or more features on a substrate, depositing a protective layer on a substantial portion of the top surface of the substrate, applying a metal filled paste to at least a portion of the one or more features, removing a substantial portion of the protective layer, and curing the metal filled paste to form one or more conductive structures. It is important to note, however, in this context, use of the term protective does not impart any particular limitations on the material or combination of materials that may comprise the protective layer, as will be explained in more detail herein.

As mentioned previously, an electronic assembly may comprise one or more electronic components coupled to a substrate, which may be a multilayer electronic substrate, for example. In this context, an electronic assembly may comprise one or more electronic components coupled to one or more substrates, and one or more electronic assemblies may be coupled to form an electronic device. Examples of electronic devices may include desktop computers, laptop computers, palmtop or handheld computers, servers, routers, cellular phones, printers, digital cameras, and the like. Those skilled in the art will recognize, however, that embodiments are not limited in this respect but may be applicable to any electronic assembly or device that comprises at least one substrate.

Present state of the art methods for fabrication of substrates with one or more layers may incorporate multiple operations. One particular technique for forming a multilayer substrate may utilize the process of first imprinting features on one layer of a substrate. Imprinting, in this context, refers to the process of forming features in a material by initially forcing a tool against the material. This may include stamping, embossing, impressing or extruding, for example. Additionally, after imprinting, formation of a multilayer substrate may incorporate etching or de-smearing the imprinted features, and application of a seed layer of an electrically conductive material such as copper. The conductive material may be applied by use of electroless plating or sputter deposition, for example. After the application of the seed layer, an electrolytic plating process may be performed to metalize the features. Metal may be overplated due to the varying feature sizes, and therefore a removal process such as grinding or etching must be performed to remove excess metalization material. Once these conductive devices are formed on one or more layers, the different substrate layers may be combined to form a multilayer substrate that may be used in an electronic assembly. As stated previously, techniques such as this may involve a long throughput time, may use excess materials resulting in high cost, and may additionally restrict the ability to form particular features.

It should be noted that while the claimed subject matter is not so limited, it is well known that numerous methods for mounting electronic components to a substrate exist, and the claimed subject matter is not limited in respect to the type of electronic assembly that may be formed from these one or more disclosed techniques. One such mounting technique may be referred to as surface mounting, which may use one or more solder balls formed on the surface of a substrate. Another mounting technique in accordance with one or more embodiments is bumpless buildup layer (BBUL) packaging, for example.

It is worthy to note that any reference in the specification to “one embodiment” or “an embodiment” means that a particular feature, structure, or characteristic described in connection with the embodiment is included in at least one embodiment of the claimed subject matter. The appearances of the phrase “in one embodiment” in various places in the specification are not necessarily all referring to the same embodiment.

Details may be set forth herein to provide a thorough understanding of particular embodiments. It will be understood by those skilled in the art, however, that the embodiments may be practiced without these specific details. In other instances, well-known methods, procedures and components have not been described in detail so as not to obscure the embodiments of the claimed subject matter. It can be appreciated that the specific structural and functional details disclosed herein may be representative and do not necessarily limit the scope of the claimed subject matter.

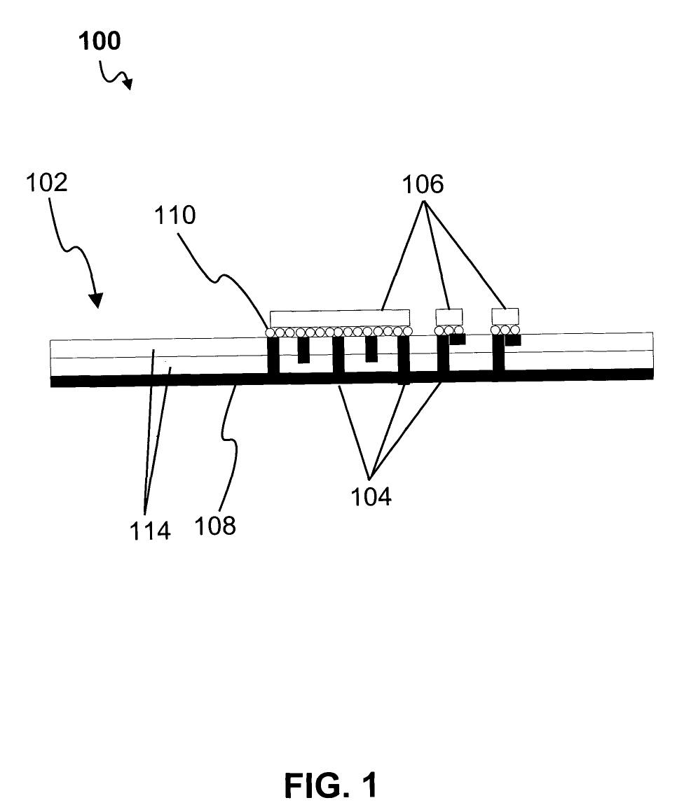

Referring now in detail to the drawings wherein like parts are designated by like reference numerals throughout, there is illustrated in FIG. 1 a side cross sectional view of an electronic assembly comprising a plurality of electronic components and a substrate, wherein the substrate may comprise a multilayer substrate, for example. Electronic assembly 100 includes a plurality of electronic components 106, which may comprise active or passive electronic components such as one or more microprocessors, digital signal processors (DSP), microcontrollers, capacitors, resistors or application specific integrated circuits (ASIC), but it is important to note that those skilled in the art appreciate that the claimed subject matter is not so limited. For example, in this embodiment, electronic components 106 are physically and electrically coupled to substrate 102, and attachment may be by use of a plurality of solder balls 110, for example. The electronic components may be coupled to one another by a hierarchy of electrically conductive paths formed by conductive structures 104, as explained in more detail herein.

Substrate 102 may comprise multiple layers, such as a core layer 108 and multiple build up layers 114, for example. These multiple layers may each contain a plurality of conductive structures 104, which may provide electrical connectivity between components 106 and substrate 102, or may provide the ability of components 104 to have input/output capability, for example. Conductive structures 104 may include, for example, traces, vias, trenches, lands, pads, or the like. Although assembly 100 is illustrated as having a core layer with two buildup layers formed thereon, it is important to note that the claimed subject matter is not limited in this respect, but may comprise an assembly with a substrate having no core layer, or with a core layer having buildup layers formed on the top and bottom, or other configurations. The multiple layers of substrate 102 may be formed from a variety of materials, including organic and/or ceramic materials, for example. Organic materials may include partially cured organic materials, chemically or thermally softened organic materials, or the like, but may comprise any other suitable material capable of being imprinted and having one or more conductive features formed thereon.

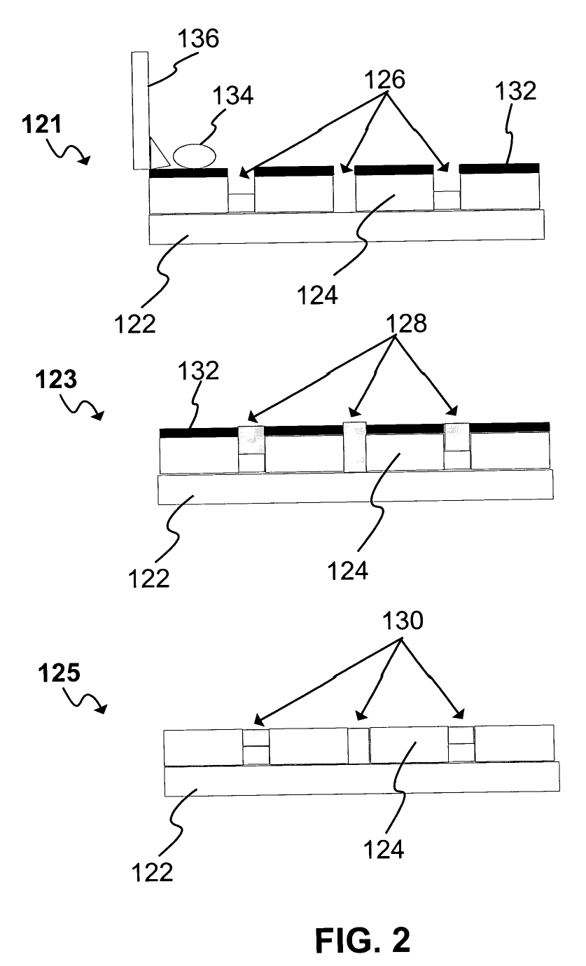

Referring now to FIG. 2, there is illustrated phases in the formation of a substrate according to an embodiment. Illustrated in FIG. 2 is a side cross sectional view of three phases of formation of a substrate with conductive structures being formed thereon. It is important to note, however, that these three phases are for illustrative purposes only, and the claimed subject matter is not limited to just these three phases or these three phases in any particular order, and, additionally, FIG. 2 illustrates formation of a substrate layer on a substrate core, but particular embodiments is not limited to any particular number or configuration of substrate layers. Shown in all three phases 121, 123 and 125 are substrate layer 124 coupled to substrate core 122. In phase 121, partially formed conductive structures 126 are shown prior to any metalization process. Partially formed conductive structures 126 may be formed by one or more imprinting processes as previously described, for example. Those of skill in the art will appreciate that there are numerous techniques for forming, however.

One or more layers such as layer 132 may be formed on a substantial portion of substrate layer 124, and may be formed after completion of the imprinting process, for example. These one or more layers may comprise a resist or a stencil, for example, and may be applied to the exposed top surface of substrate layer 124, for example. Application of layer 132 may depend on the particular type of material used as a layer, but one particular embodiment may utilize a layer of nickel, copper or aluminum, for example, applied by use of a sputter process. After application of layer 132, paste 134 may be applied to at least a portion of the partially formed conductive structures 126. A squeegee device 136 may be used to apply a paste 134 to at least a portion of the formed conductive structures 126. Squeegee device 136 may be applied along the top surface of layer 132, for example, and force paste 134 into one or more of the partially formed conductive structures 126, resulting in the further formation of partially formed conductive structures 126 as shown in phase 123 of FIG. 2.

In this embodiment, the metal filled paste may comprise one or more types of metal filled paste: point contact paste, metal fusion paste, or chemical reaction paste, for example. Point contact paste may comprise a paste at least partially filled with metal powder. Chemical reaction paste may comprise a paste combined with particles of metal, wherein the particles may be particles of a particular diameter in nanometers, combined with particles of a larger size in diameters. Metal fusion paste may comprise a paste with metal at least partially incorporated into the paste, for example. Those skilled in the art will be aware, however, that particular embodiments is not limited to any particular paste composition, but any paste that is capable of being used to form features on a substrate may be used in at least one embodiment.

In phase 123 of FIG. 2, there is illustrated a substrate layer 124 with partially formed conductive structures 128. The metal filled paste applied to the imprinted areas of substrate layer 124 may further form conductive structures 128. As illustrated in phase 123, residual paste may remain above the top surface of layer 132, for example, depending on the method used to apply the paste, for example. Phase 125 illustrates further formation of substrate layer 124, with metalized conductive structures 130. After application of the metal filled paste, one or more reflow or curing processes may be used to form conductive structures 130. After these one or more reflow or curing processes, removal of at least a portion of layer 132, as well as excess paste, which may be paste above the top surface of layer 124, may be performed. Removal of layer 132 and/or excess paste may be by use of a mechanical process such as grinding or polishing, or may comprise an etching process, for example. However, the particular process used may depend on the material used as a resist or stencil layer, for example, and may depend on the type of paste used to form features. Alternatively, if no resist or stencil layer is used this operation may only be used if there is excess paste on the substrate, such as on the top surface of the substrate, for example, and, in this case, one or more grinding and/or polishing processes may be used to remove paste. This may result in the formation of metalized conductive structures 130 in substrate layer 124, resulting in the formation of a substrate with a buildup layer and a core layer, which may be used in an electronic assembly, for example.

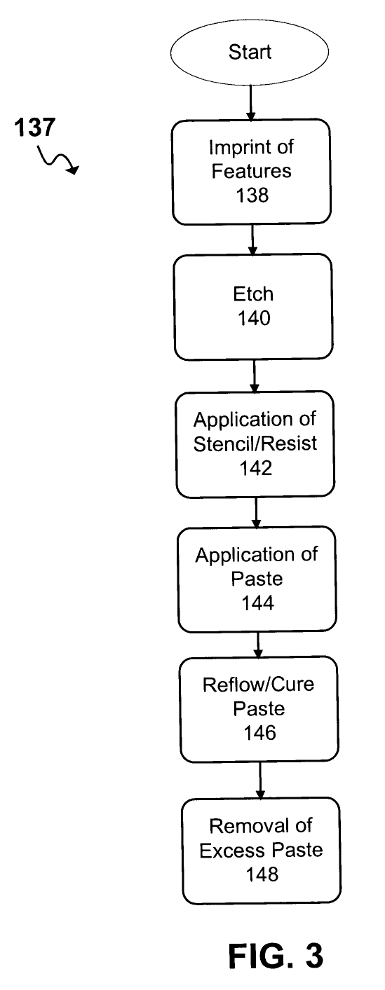

FIG. 3 illustrates the process flow 137 that may be utilized in one embodiment of the formation of a substrate with metalized conductive structures such as illustrated in FIG. 2. Although FIG. 3 illustrates a particular process flow, the order presented does not infer a particular order of execution, nor does it infer that all functional blocks need be performed in all embodiments. In this embodiment, at block 138, features are imprinted on a substrate; the substrate features are then subjected to one or more etch processes at block 140; a stencil or resist layer is applied to the substrate at block 142; and paste is applied to the substrate at block 144, wherein the paste is applied to the imprinted features formed previously. After application of paste, one or more reflow and/or curing processes are incorporated to cure the paste at block 146. After the paste is cured, one or more processes to remove excess paste may be used to finalize the formation of metalized conductive structures on the substrate at block 148.

In this embodiment, at block 138, imprinting may comprise applying one or more tools against or in to a material to form features with particular geometries, for example. The tool(s) may comprise one or more devices with various protrusions and dies with different geometries, which may represent traces, trenches, or other features, for example. A tool such as this may be forced into a substrate layer, with a particular force to provide one or more voids in the substrate, which represent partially formed conductive structures of particular geometries. A substrate used as a substrate layer may comprise a resin, epoxy, liquid crystal polymer or polycarbonate, for example, although particular embodiments are not so limited.

In this embodiment, at block 140, one or more etching processes may comprise use of one or more cleaning processes to remove material left from one or more imprinting processes. Material may be left in the voids formed by imprinting, or may be left on the top surface of the substrate, for example. Although in this embodiment an etching process such as plasma etching is utilized, a method which removes residual material in order to complete the formation of imprinted features is in accordance with one or more particular embodiments. For example, a grinding, drilling or other machining process, or a chemical process such as a wet etch may be used to remove material.

In this embodiment, at block 142, application of a stencil and or resist layer may comprise applying at least one layer of material to the substrate, which may be applied to the top surface of the substrate, for example. This layer may be applied by use of one or more screen printing or spraying processes, for example, but any method that results in the application of at least one layer of material on a substantial portion of the top surface of the substrate is in accordance with particular embodiments. In one embodiment, a layer of photoresist is applied by use of dry film lamination or spin coating, for example, to the top surface of the substrate, but multiple well known techniques for applying photoresist exist, and particular embodiments is not so limited.

In this embodiment, at block 144, application of paste may comprise use of a squeegee device to apply paste at least partially into one or more imprinted features, for example. In this embodiment, while a screen printing process is used to apply the paste, any method of forcing paste into at least a portion of the imprinted features of a substrate are in accordance with particular embodiments.

In this embodiment, at block 146, one or more reflow and/or curing processes may comprise elevating the temperature of the substrate with metal filled paste applied to imprinted features for a particular period of time. This particular process may depend at least in part on the type of paste used to form features in the substrate, but any method that results in curing of paste is in accordance with particular embodiments.

In this embodiment, at block 148, one or more processes to remove at least a portion of the resist or stencil layer, as well as removal of any excess paste may comprise a mechanical process such as grinding or polishing, or may comprise an etching process, for example. Again, the particular process used may depend on the material used as a resist or stencil layer, for example, and may depend on the type of paste used to form features. Alternatively, if no resist or stencil layer is used this operation may only be used if there is excess paste on the substrate, such as on the top surface of the substrate, for example.

It can be appreciated that the embodiments may be applied to the formation of a substrate. Certain features of the embodiments have been illustrated as described herein, however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with particular embodiments. It is, therefore, to be understood that the appended claims are intended to cover all such modifications and changes as fall within the true spirit of particular embodiments.

1. A method of forming an electronic device substrate, comprising:
imprinting one or more features on a substrate;
forming a protective layer on a substantial portion of the top surface of the substrate;
applying a metal filled paste to at least a portion of the one or more features; and
removing a substantial portion of the protective layer.

2. The method of claim 1, further comprising curing at least a portion of the metal filled paste.

3. The method of claim 1, wherein imprinting further comprises one or more of: stamping, embossing impressing and extruding.

4. The method of claim 1, wherein a printed circuit board (PCB) comprises the substrate.

5. The method of claim 1, wherein the depositing comprises one or more of: electroless plating and sputter deposition.

6. The method of claim 1, wherein applying a metal filled paste further comprises applying paste into a portion of the one or more features by use of a squeegee device.

7. The method of claim 1, wherein the removing further comprises one or more of: grinding, etching, sanding, and polishing.

8. The method of claim 1, wherein the curing comprises elevating the temperature of the substrate until a phase change occurs in at least a portion of the metal filled paste.

9. The method of claim 7, wherein the temperature is at least equal to the reflow temperature of the metal filled paste.

10. A method of forming an electronic device substrate, comprising:
forming one or more features on a substrate;
filling, at least in part, the one or more features with paste; and
curing the paste.

11. The method of claim 10, wherein forming further comprises at least one imprinting process.

12. The method of claim 11, wherein at least one imprinting process comprises one or more of: stamping, embossing impressing and extruding.

13. The method of claim 10, wherein filling the one or more features with paste comprises filling the one or more features with metal filled paste.

14. The method of claim 13, wherein filling one or more features comprises applying a metal filled paste into a portion of the one or more features by use of a squeegee device.

15. The method of claim 13, wherein the curing comprises elevating the temperature of the substrate until a phase change occurs in at least a portion of the metal filled paste.

16. The method of claim 13, wherein the temperature is at least equal to the reflow temperature of the metal filled paste.

17. The method of claim 13, and further comprising: applying a protective layer on at least a portion of the substrate prior to applying metal filled paste.

18. An apparatus, comprising:
one or more electronic substrates, at least one of the one or more electronic substrates having a plurality of conductive structures formed thereon, the conductive structures being imprinted into the substrate, and at least partially filled with one or more types of metal filled paste.

19. The apparatus of claim 18, wherein the electronic substrate comprises a circuit board.

20. The apparatus of claim 18, wherein at least a portion of the conductive structures comprise traces.

21. The apparatus of claim 18, wherein the apparatus comprises an electronic device.

22. The apparatus of claim 18, further comprising a plurality of electronic substrates, the plurality of electronic substrates coupled to form an electronic device substrate.

23. The apparatus of claim 18, wherein the metal filled paste comprises one of: point contact paste, metal fusion paste or chemical reaction paste.
